(19) United States
(12) Patent Application Publication
(10) Pub. No.: US 2009/0193035 A1
(43) Pub. Date: Jul. 30, 2009

(54) COLLABORATIVE DOCUMENT MANAGEMENT

(75) Inventors: Jay William Benayon, Thornhill (CA); Aparna Katti, Mississauga (CA)

Correspondence Address: AKERMAN SENTERFITT, P.O. BOX 3188, WEST PALM BEACH, FL, 33402-3188, US

(73) Assignee: INTERNATIONAL BUSINESS MACHINES CORPORATION, Armonk, NY (US)

(21) Appl. No.: 12/018,947

(22) Filed: Jan. 24, 2008

(51) Int. Cl. G06F 17/30

(52) U.S. Cl. 707/100; 707/E17.005

(57) ABSTRACT

A method for processing documents is provided, including the steps of retrieving a document stored in a first format, converting the retrieved document to a second format according to a conversion profile associated with the second format, presenting the converted document, responsive to a request to store an updated version of the converted document, converting the updated document back into the first format and updating the conversion profile with one or more conversion customizations specified for the updated document, and storing the updated document in the first format.

### FIELD OF THE INVENTION

The present invention relates to the field of collaborative document management, and more particularly, to systems and methods for managing presentation and updating of collaborative documents.

### BACKGROUND

In general, currently available document management tools in the market support globalization. These tools also typically include the ability for users to specify locale settings, such as time zones, calendar options (e.g., weekly holidays), and date formats. Many of these tools generally include the ability to re-render flow diagrams and rearrange text in a direction based on the locale setting (e.g., in Arabic locale, the text will be viewed in Arabic with the diagram and text direction from right to left).

However, these tools generally lack some key user-customizable features that are necessary for true collaborative document management. In general, these tools allow a user to author a document in the current locale (e.g., English-Canada) and publish this document for use by other users. Unfortunately, other users in a different locale (e.g., Arabic) must either view the document as originally stored or are generally forced to see the document formatted based on settings for their locale.

In some cases, such tools can include translation capabilities, but the capabilities are generally limited. These tools can typically provide an accurate translation for portions of the documents using pre-defined text into various languages. User-entered text, however, is typically left untranslated or, worse, is literally translated. Literal translation can often result in an incorrect, inaccurate, and/or incomprehensible translation of the original document. For example, in a process modeling application, user-defined text, such as task names, in the original language of a document can be immediately translated for a user in reading Arabic using the predefined text specified in Arabic. However, descriptive information in the process model associated with a task would be left untranslated or would be literally (and perhaps incorrectly) translated.

Therefore, what is needed is a system and method for providing user-defined customizations features for a collaborative document management tools.

### SUMMARY

In a first embodiment of the present invention, a method for processing documents can include the steps of retrieving a document stored in a first format, converting the retrieved document to a second format according to a conversion profile associated with the second format, and presenting the converted document. The method can further include the steps of converting the updated document back into the first format responsive to a request to store an updated version of the converted document, updating the conversion profile with one or more conversion customizations specified for the updated document, and storing the updated document in the first format.

In a second embodiment of the present invention, a system for processing documents can include at least one user interface associated with at least one user, a storage element for storing a document in a first format, and a processing element configured to retrieve the document from the storage element, convert the retrieved document according to a conversion profile to a second format, present the converted document using the user interface, and store an updated version of the document in the storage element. Responsive to a request to store the updated version of the document, the processing element of the system can convert the updated document back into the first format and update the conversion profile with one or more conversion customizations specified for the updated document.

In a third embodiment of the present invention, a computer-readable storage is provided, having stored thereon a computer program comprising a plurality of code sections, the code sections executable by a computer for causing the computer to perform the steps of: retrieving a document stored in a first format, converting the retrieved document to a second format according to a conversion profile associated with the second format, and presenting the converted document. The computer-readable storage can also include code sections for: storing an updated version of the converted document in response to a request, converting the updated document back into the first format and updating the conversion profile with one or more conversion customizations specified for the updated document, and storing the updated document in the first format.

### BRIEF DESCRIPTION OF THE DRAWINGS

The present invention is described with reference to the attached figures, wherein like reference numerals are used throughout the figures to designate similar or equivalent elements. The figures are not drawn to scale and they are provided merely to illustrate the instant invention.

FIG. 1 is a schematic view of an exemplary communications system supporting collaborative document management according to an embodiment of the present invention.

FIG. 2 is a flowchart of exemplary steps of a method for collaborative document management according to an embodiment of the present invention.

FIG. 3A is an exemplary embodiment of a document stored according to an embodiment of the present invention.

FIG. 3B is an exemplary embodiment of the document of FIG. 3A reformatted according to an embodiment of the present invention.

FIG. 4 is a schematic view of a computer system within which a set of instructions operate according to an embodiment of the present invention.

### DETAILED DESCRIPTION OF THE DRAWINGS

Embodiments of the present invention provide systems and methods for managing collaborative documents by allowing users to specify a customized presentation format for presenting and editing collaborative documents. One aspect of the present invention provides for a conversion profile to be specified for converting a document. The conversion profile defines a method for transforming the format of the stored document into a user-defined format. A format, as used herein, refers to the style for the reformatted document (e.g., fonts, time and date formats, number formats, and monetary formats), a layout for the reformatted document (e.g., spacing, diagram flow direction, language direction), a translation dictionary (language) for the reformatted document. In a collaborative document system, conversion profiles can be associated with particular users, groups of user, or users accessing documents through one or more specified computing systems.

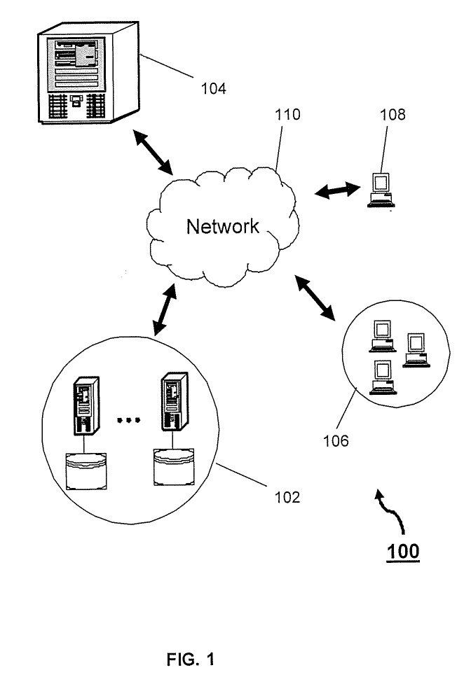

FIG. 1 depicts an exemplary embodiment of a system 100 for managing collaborative documents. The system 100 can comprise one or more storage devices, such as mass storage devices (MSDs) 102, accessible by a document management system (DMS) 104 that manages execution of collaborative document management processes, such as retrieval, format conversion, and storage of documents in the MSDs 102. In the exemplary system 100, requests for collaborative document management processes can be submitted to the DMS 104 from one or more user interfaces or terminals 106. Optionally, the DMS 104 can also be monitored and managed via an administrator interface 108 that provides administrator access to the DMS 104. Through the administrator access 108, conversion profiles can be initially created, imported, or associated with one or more documents. However, the invention is not limited in this regard and the system 100 can also be configured to allow creation, importation, and association of conversion profiles through other interfaces, including one or more of the user terminals 106.

Although shown as a single computing system, the DMS 104 can be represented as centralized or decentralized computing devices. In the system 100, terminals 106, are shown connected by way of wire line or wireless access paths through a network 110 to the DMS 104. In embodiments where the DMS 104 comprises a distributed system, one or more of the terminals 106 can be connected to the same or different components of the DMS 104 over the network. MSDs 102 can also operate as single computing systems or as centralized or decentralized computing devices. For example, in the exemplary system 100, MSDs 102 can comprise one or more local or remote computing systems deployed over a network 110. Furthermore, although the DMS 104 and the MSDs 102 are shown as separate systems, it is also within the scope of the invention for the DMS 104 and the MSDs 102 to operate as a single computing system.

Additionally, it is within the scope of the invention for a terminal 106 to represent any multimode communication device including, but not limited to, a cell phone, a personal computer or laptop, or personal digital assistant capable of supporting wire line and/or wireless communication technologies. In the case of wire line communications, a terminal 106 can utilize xDSL, cable, or PSTN telephony interfaces for communicating over the network 110, which can include hybrid technologies that support circuit-switched packet-switched communications. The terminal 106 can also support accessory interfaces such as USB, Firewire, and other connectivity technologies.

Alternatively, or in combination, the terminal 106 can support any number of wireless communication protocols such as the family of 802.xx protocols defined by the Institute of Electrical and Electronics Engineers (IEEE). For instance, terminal 106 can utilize long-range wireless access technologies such as, for example, cellular, software defined radio (SDR) and/or WiMAX to communicate with the network 110. Cellular access technologies can include, for example, CDMA-1X, UMTS/HSDPA, GSM/GPRS, TDMA/EDGE, EV/DO, and next generation technologies as they emerge. Additionally, a terminal 106 can support short-range wireless technologies such as WiFi, Bluetooth, Zigbee, or cordless communications such as digital enhanced cordless telecommunications (DECT).

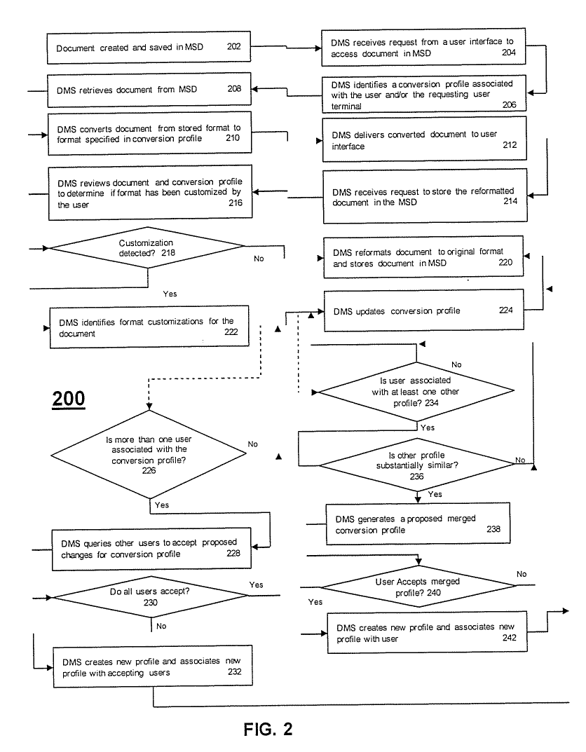

FIG. 2 is a flowchart illustrating steps in an exemplary method 200 for managing collaborative documents according to an embodiment of the present invention. In step 202, a document can be initially created and saved in a MSD. Once the document is created, the document can be accessed by one or more users via a user terminal, as previously discussed. Accordingly, in step 204, the DMS can receive one or more requests for access to the document stored in the MSD. Responsive to this request, the DMS, in step 206, can identify a conversion profile to be used for presenting the document on the requesting user terminal.

In the various embodiments, the location of the conversion profile can vary. For example, in some embodiments, the conversion profile can be stored in the DMS, the MSD, a user terminal, or other component in the network. The conversion profile can be stored as a single file or as an entry in a database or lookup table for multiple conversion profiles. In other embodiments, a conversion profile can be attached to the requested document. That is, the conversion profile can be included as an additional part of the document to be used only for determining how to display the document. Furthermore, the method of selecting the correct conversion profile can vary. For example, in one embodiment, the conversion profile selected can be based on the particular user making the request. In another example, the conversion profile selected can be based on whether a user is associated with a particular group. In yet another example, the conversion profile can be based on the particular terminal being used.

Separately, or in combination with the identification of the correct conversion profile in step 206, the DMS, in step 208, can retrieve the document requested. Using the identified conversion profile, the DMS, in step 210, can then convert the format of the requested document to that specified in the conversion profile. As previously discussed, the conversion process results in the document presentation format being altered. For example, the style (e.g., fonts, time and date formats, number and monetary formats), a layout (e.g., spacing, diagram flow direction, language direction), and language of the stored document can be reformatted as specified in the conversion profile.

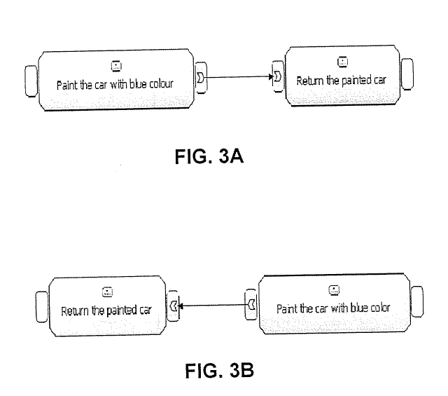

For example, in a graphical process modeling tool, a exemplary process can be designed to include two tasks: (1) “Paint the car with blue colour” and (2) “Return the painted car” as shown in FIG. 3A. In this exemplary process, the diagram flows from left to right and the text is shown using a Canadian English vocabulary. Accordingly an exemplary conversion profile can specify the following: (1) use of a right to left diagram layout and (2) use of an American English vocabulary. Applied to the original process flow, the process flow can be displayed according to the conversion profile described above, resulting in the display of the process flow as shown in FIG. 2B. In FIG. 2B, the order of the tasks and connecting arrows is reversed and the Canadian English word “colour” has been replaced with the American English word “color.”

Although the example illustrated above is shown in terms of a graphical process modeling tool and is limited to changes in diagram direction and language, the invention is not limited in this regard. In the various embodiments of the present invention, conversion profiles can be used to reformat any type of documents, including, but not limited to, manuscripts and other text documents, presentations, spreadsheets or other accounting documents, or any type of markup language text (e.g., DHTML, HTML, XML, and VXML).

Referring back to FIG. 2, once the document is converted in step 210, the DMS can deliver the converted document to the requesting user interface in step 212. The user can then view and, if necessary, make changes to the document. Accordingly, the DMS can receive a request from the user in step 214 to store the updated or edited document in the MSD. However, another aspect of the present invention provides for always storing the document in the same format. That is, rather than storing the document in the format being edited by the user, the document is always stored in a single format. For example, the document can be stored in the format it was originally created. In another example, the document can be stored in a fixed format always, even if the format is different from the format originally used to create the document. Storing the document using a single base format reduces the risk of mistranslation due to multiple re-translations.

As previously described, a conversion profile can be created via the user interface or an administrative interface. However, creation of the profile need not be concurrent with creation of the document. Although the creator of the document can generate initial conversion profiles based on his knowledge of the users that will access the document, the creator can leave this task to the DMS. For example, rather than create a profile, the DMS can initially reformat the document according to the current settings in the user terminal. Afterwards, when the user requests that the document be stored, these settings, along with any changes made by the user, can be used to create the initial conversion profile. In another example, the DMS can be provided with a list of users and their locales and generate initial conversion profiles for the users based on their locales. Afterwards, when the user requests that the document be stored, any changes made by the user can be used to update the initial conversion profile.

Therefore, in response to the user's request, the DMS can first examine the document and determine if a change in the formatting has occurred in step 216. For example, the DMS can detect that a change in vocabulary has occurred, resulting in a translation of a specific word or phrase that is different from that stored in the translation dictionary of the conversion profile originally used to reformat the document. In another example, the DMS can detect that the orientation for text or for a diagram is different from that specified during the original conversion. In yet another example, the DMS can detect that the format changes have only been applied to certain types of fields, such as reversing the direction of only specific types of diagrams, while allowing text and other diagram portions to remain in the direction they were originally reformatted to. However, if the DMS detects no changes in format in step 218, the DMS, in step 220, can reformat the document back into its original format and store the updated document in the MSD 102. If the DMS does detect a change in the format in step 218, the DMS can identify the specific changes in format in step 222 and update the conversion profile being used in step 224. Afterwards, the DMS can reformat the document back into its original format and store the updated document in the MSD in step 220.

In some embodiments, the conversion profile being used can be associated with multiple users. In such embodiments, some users may not approve of the changes being made in the profile. Therefore, another aspect of the present invention provides for generating a new profile if at least one user disagrees with the changes. For example, after the DMS identifies the customization in step 222, the DMS can determine in step 226 if any other users are associated with the profile being updated. If no other users are associated with the profile in step 226, the DMS can update the profile immediately, as previously discussed. However, if multiple users are found in step 226, the DMS can query these other users in step 228 as to whether they accept the proposed changes. If all users accept the changes in step 230, the DMS can then update the profile immediately in step 224, as previously discussed. If at least one user objects, the DMS, in step 232, can instead create a new profile including the proposed changes and associate all approving users with the new profile. Afterwards, the DMS can reformat the document back into its original format and store the updated document in the MSD.

In other embodiments, multiple conversion profiles can be associated with a single user. In such embodiments, the user may be unaware that multiple profiles have been created that are substantially the same. Such a circumstance can occur when different profiles created for the user for different types of documents may have been updated to such an extent that the remaining differences between the profiles are limited. For example, the profiles may only have a few differences in the translation dictionary. In another example, the differences can specify only minor cosmetic differences, such as font or spacing. In other words, the differences are such that the appearance and language of a document using either profile is almost the same or that at least the differences are irrelevant to the display and understanding of the document.

Therefore, yet another aspect of the present invention provides for merging existing profiles if the user agrees. For example, after the DMS identifies the customization in step 222, the DMS can determine in step 234 if any other profiles are associated with the user. Afterwards, in step 236, the DMS can determine if the current profile is substantially similar to any other profile associated with the user. If no profiles are substantially similar, the DMS can then update the profile immediately, as previously discussed in step 224. However, if at least one similar profile is found, the DMS can propose to the user that a merged profile be created in step 238. If the user rejects the proposed merger of profiles in step 240, the DMS can then update the profile immediately, as previously discussed in step 224. If the user accepts the proposed merged profile in step 240, the DMS can create a new profile and associate the user with the new profile in step 242. Afterwards, the DMS can reformat the document back into its original format and store the updated document in the MSD in step 220.

Upon reviewing the aforementioned embodiments, it would be evident to one of ordinary skill in the art that the embodiments can be modified, reduced, or enhanced without departing from the scope and spirit of the claims described below. For example, in some embodiments, multiple users can be associated with multiple profiles. Accordingly, if the DMS proposes to merge multiple profiles, all associated users can be queried to determine if all users approve the merger of the profiles. In such cases, a new merged profile can be created for those users approving the merger, leaving the original profiles intact.

In another embodiment, when changes are made to a profile, the changes can be applied automatically to all documents using the profile. That is, if a second user approves profile changes made by a first user, the changes can be applied immediately to the document the second user is currently using. Similarly, if a user with multiple profiles merges two or more of the profiles, the merged profile can be applied immediately to all documents currently in use by the user. In yet another embodiment, when changes in a profile are proposed, changes are only accepted if specific users approve. For example, a super-user can be defined to monitor the changes to ensure a constant application of some format changes, such as language translations. In these embodiments, the super-user can approve or reject changes and force all other users to accept one or more specific changes. In still another embodiment, when multiple changes are proposed to multiple users, some users may accept some, if not all the changes. In such embodiments, if a sufficient number of users agree on a limited number of changes, another new profile can be created for these users. These are but a few examples of modifications that can be applied to the present disclosure without departing from the scope of the claims stated below. Accordingly, the reader is directed to the claims section for a fuller understanding of the breadth and scope of the present disclosure.

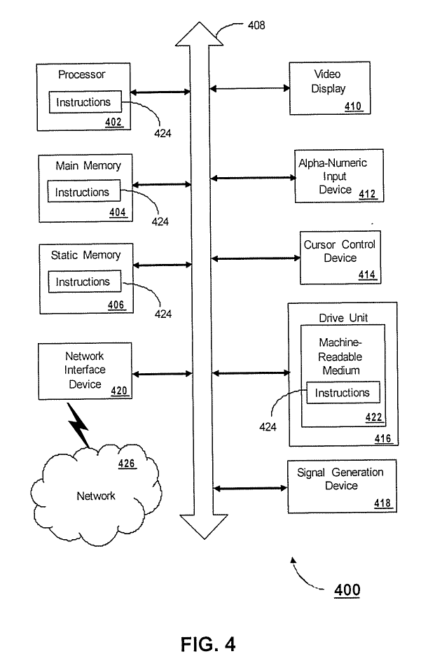

FIG. 4 is a schematic diagram of a computer system 400 for executing a set of instructions that, when executed, can cause the computer system to perform one or more of the methodologies and procedures described above. In some embodiments, the computer system 400 operates as a standalone device. In other embodiments, the computer system 400 can be connected (e.g., using a network) to other computing devices. In a networked deployment, the computer system 400 can operate in the capacity of a server or a client developer machine in server-client developer network environment, or as a peer machine in a peer-to-peer (or distributed) network environment.

The machine can comprise various types of computing systems and devices, including a server computer, a client user computer, a personal computer (PC), a tablet PC, a laptop computer, a desktop computer, a control system, a network router, switch or bridge, or any other device capable of executing a set of instructions (sequential or otherwise) that specifies actions to be taken by that device. It is to be understood that a device of the present disclosure also includes any electronic device that provides voice, video or data communication. Further, while a single computer is illustrated, the phrase “computer system” shall be understood to include any collection of computing devices that individually or jointly execute a set (or multiple sets) of instructions to perform any one or more of the methodologies discussed herein.

The computer system 400 can include a processor 402 (such as a central processing unit (CPU), a graphics processing unit (GPU, or both), a main memory 404 and a static memory 406, which communicate with each other via a bus 408. The computer system 400 can further include a display unit 410, such as a video display (e.g., a liquid crystal display or LCD), a flat panel, a solid state display, or a cathode ray tube (CRT)). The computer system 400 can include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 can include a computer-readable storage medium 422 on which is stored one or more sets of instructions 424 (e.g., software code) configured to implement one or more of the methodologies, procedures, or functions described herein. The instructions 424 can also reside, completely or at least partially, within the main memory 404, the static memory 406, and/or within the processor 402 during execution thereof by the computer system 400. The main memory 404 and the processor 402 also can constitute machine-readable media.

Dedicated hardware implementations including, but not limited to, application-specific integrated circuits, programmable logic arrays, and other hardware devices can likewise be constructed to implement the methods described herein. Applications that can include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the exemplary system is applicable to software, firmware, and hardware implementations.

In accordance with various embodiments of the present disclosure, the methods described herein can be stored as software programs in a computer-readable storage medium and can be configured for running on a computer processor. Furthermore, software implementations can include, but are not limited to, distributed processing, component/object distributed processing, parallel processing, virtual machine processing, which can also be constructed to implement the methods described herein.

The present disclosure contemplates a computer-readable storage medium containing instructions 424 or that receives and executes instructions 424 from a propagated signal so that a device connected to a network environment 426 can send or receive voice and/or video data, and that can communicate over the network 426 using the instructions 424. The instructions 424 can further be transmitted or received over a network 426 via the network interface device 420.

While the computer-readable storage medium 422 is shown in an exemplary embodiment to be a single storage medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but not be limited to, solid-state memories such as a memory card or other package that houses one or more read-only (non-volatile) memories, random access memories, or other re-writable (volatile) memories; magneto-optical or optical medium such as a disk or tape; as well as carrier wave signals such as a signal embodying computer instructions in a transmission medium; and/or a digital file attachment to e-mail or other self-contained information archive or set of archives considered to be a distribution medium equivalent to a tangible storage medium. Accordingly, the disclosure is considered to include any one or more of a computer-readable medium or a distribution medium, as listed herein and to include recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments can be utilized and derived therefrom, such that structural and logical substitutions and changes can be made without departing from the scope of this disclosure. Figures are also merely representational and can not be drawn to scale. Certain proportions thereof may be exaggerated, while others may be minimized. Accordingly, the specification and drawings are to be regarded in an illustrative rather than a restrictive sense.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method for processing documents, comprising
retrieving a document stored in a first format;
converting the retrieved document to a second format according to a conversion profile associated with the second format;
presenting the converted document;
responsive to a request to store an updated version of the converted document, converting the updated document back into the first format and updating the conversion profile with one or more conversion customizations specified for the updated document; and
storing the updated document in the first format.

2. The method of claim 1, wherein the conversion profile specifies at least one among a style, a layout, and a translation dictionary associated with the second format.

3. The method of claim 2, wherein at least one of the conversion customizations specifies a user-defined translation in the translation dictionary for a specific word or phrase in the first format.

4. The method of claim 1, wherein the conversion profile further specifies at least one field in the retrieved document to convert to the second format.

5. The method of claim 1, wherein the conversion profile is specified by at least one among a user and a user interface.

6. The method of claim 1, wherein the conversion profile is associated with multiple users, the step of updating further comprising:
prior to the updating of the conversion profile, notifying the associated users of the customizations proposed for the profile;
querying the users for approval of the proposed customizations; and
responsive to at least one of the users rejecting at least one of the proposed customizations, creating a new conversion profile including the rejected customizations and associating with the new conversion profile one or more of the users approving the rejected customizations.

7. The method of claim 1, wherein the conversion profile and another conversion profile are associated with one or more users, the method further comprising:
comparing the conversion profiles;
if the conversion profiles are substantially similar, proposing to the users a merged conversion profile; and
responsive to at least one of the users approving the proposed conversion profile, creating a new conversion profile according to the proposed merged profile and associating with the new conversion profile one or more of the users approving the merged profile.

8. A system for processing documents, comprising:
at least one user interface associated with at least one user;
a storage element for storing a document in a first format; and
a processing element configured to: retrieve the document from the storage element, convert the retrieved document according to a conversion profile to a second format, present the converted document using the user interface, and store an updated version of the document in the storage element,
wherein responsive to a request to store the updated version of the document, the processing element converts the updated document back into the first format and updates the conversion profile with one or more conversion customizations specified for the updated document.

9. The system of claim 8, wherein the conversion profile specifies at least one among a style, a layout, and a translation dictionary associated with the second format.

10. The system of claim 9, wherein at least one of the conversion customizations specifies a user-defined translation in the translation dictionary for a specific word or phrase in the first format.

11. The system of claim 8, wherein the conversion profile further specifies at least one field in the retrieved document to convert to the second format.

12. The system of claim 8, wherein the conversion profile is associated with multiple users, and wherein the processing element is further configured to:
notify the associated users of the customizations proposed for the conversion profile prior to the updating of the conversion profile;
query the associated users for approval of the proposed customizations; and
create a new conversion profile and associate the new conversion profile with one or more of the users approving the rejected customizations responsive to at least one of the users rejecting at least one of the proposed customizations, wherein the new conversion profile includes the rejected customizations.

13. The system of claim 8, wherein the conversion profile and another conversion profile are associated with one or more users, wherein the processing element is further configured to:
compare the conversion profiles;
propose to the users a merged conversion profile if the conversion profiles are substantially similar; and
create a new conversion profile according to the proposed conversion profile in response to at least one of the users approving the proposed conversion profile, and associating with the new conversion profile one or more of the users approving the merged profile.

14. A computer-readable storage, having stored thereon a computer program comprising a plurality of code sections, the code sections executable by a computer for causing the computer to perform the steps of:
retrieving a document stored in a first format;
converting the retrieved document to a second format according to a conversion profile associated with the second format;
presenting the converted document;
responsive to a request to store an updated version of the converted document, converting the updated document back into the first format and updating the conversion profile with one or more conversion customizations specified for the updated document; and
storing the updated document in the first format.

15. The computer-readable storage of claim 14, wherein the conversion profile specifies at least one among a style, a layout, and a translation dictionary associated with the second format.

16. The computer-readable storage of claim 15, wherein at least one of the conversion customizations specifies a user-defined translation in the translation dictionary for a specific word or phrase in the first format.

17. The computer-readable storage of claim 14, wherein the conversion profile further specifies at least one field in the retrieved document to convert to the second format.

18. The computer-readable storage of claim 14, wherein the conversion profile is specified by at least one among a user and a user interface.

19. The computer-readable storage of claim 14, wherein the conversion profile is associated with multiple users, the step of updating further comprising code sections for:
prior to the updating of the conversion profile, notifying the associated users of the customizations proposed for the profile;
querying the users for approval of the proposed customizations; and
responsive to at least one of the users rejecting at least one of the proposed customizations, creating a new conversion profile including the rejected customizations and associating with the new conversion profile one or more of the users approving the rejected customizations.

20. The computer-readable storage of claim 14, wherein the conversion profile and another conversion profile are associated with one or more users, further comprising code sections for:
comparing the conversion profiles;
if the conversion profiles are substantially similar, proposing to the users a merged conversion profile; and
responsive to at least one of the users approving the proposed conversion profile, creating a new conversion profile according to the proposed merged profile and associating with the new conversion profile one or more of the users approving the merged profile.
